(19) United States
(12) Patent Application Publication
(10) Pub. No.: US 2026/0032402 A1
(43) Pub. Date: Jan. 29, 2026

(54) SOUND PROPAGATION CHARACTERISTICS CORRECTION APPARATUS, SOUND PROPAGATION CHARACTERISTICS CORRECTION METHOD, AND PROGRAM

(71) Applicant: NIPPON TELEGRAPH AND TELEPHONE CORPORATION, Tokyo (JP)

(72) Inventors: Shihori KOZUKA, Tokyo (JP); Hiroaki ITO, Tokyo (JP); Kenichi NOGUCHI, Tokyo (JP); Tatsuya KAKO, Tokyo (JP); Hironobu CHIBA, Tokyo (JP)

(73) Assignee: NIPPON TELEGRAPH AND TELEPHONE CORPORATION, Tokyo (JP)

(21) Appl. No.: 18/997,283

(22) PCT Filed: Jul. 28, 2022
(86) PCT No.: PCT/JP2022/029172

§ 371 Date: Jan. 21, 2025

(51) Int. Cl. H04S 7/00; H04R 3/04; H04R 5/033; H04R 5/04

(52) U.S. Cl. CPC H04S 7/307; H04R 3/04; H04R 5/033; H04R 5/04; H04R 2430/03; H04S 2420/07

(57) ABSTRACT

A sound propagation characteristics correction apparatus includes: a pseudo inverse filter generation unit that generates a pseudo inverse filter by a function that smooths sound propagation characteristics from a speaker driver of a wearable open-ear speaker to an ear canal entrance; and an acoustic signal correction unit that corrects an acoustic signal on the basis of the pseudo inverse filter and transmits the corrected acoustic signal to the wearable open-ear speaker.

### TECHNICAL FIELD

The present disclosure relates to a sound propagation characteristics correction apparatus, a sound propagation characteristics correction method, and a program for correcting sound propagation characteristics in order to perform stereophonic sound reproduction with a wearable speaker (hereinafter, a wearable open-ear speaker) that does not block an ear canal.

### BACKGROUND ART

Stereophonic sound reproduction is a technique of reproducing a sound with a speaker as if the sound is transmitted from a sound source located outside a speaker (for example, wearable speakers, headphones, earphones).

The sound sound propagation characteristics from the wearable speaker to the user's ear greatly affect the localization sensation of the sound source. In particular, the localization sensation in the elevation angle direction is greatly affected, and in order to cause accurate perception, it is necessary to cancel the sound sound propagation characteristics based on the presence of the wearable speaker casing at the ear and to bring the frequency characteristics between a sound desired to be heard and a sound actually heard close to flat.

In order to improve the elevation angle perception accuracy in conventional closed headphones, a plurality of techniques for constituting an inverse filter that cancels frequency characteristics of a casing have been proposed (for example, Non Patent Literature 1). Hereinafter, a formula of an inverse filter H_{c}(x) in Non Patent Literature 1 will be described.

$${H}_{C} ( x ) = \frac{D ( x ) {H}^{*} ( x )}{H ( x ) {H}^{*} ( x ) + β B ( x ) {B}^{*} ( x )} \qquad [ Math . 1 ]$$

H_{c}(x): Inverse filter (unknown)
D(x): Bandpass filter (known)
H(x): Frequency characteristics of headphones (known, determined from measurement)
B(x): High-pass filter for regularization (or 1/H(k)) (known)
β: Weight of regularization term (known, determined from subjective evaluation)
* represents conjugation. The filter H_{c}(x) is an inverse filter that can designate the strength of regularization for each frequency, and B(x) is used to designate that regularization on the high-frequency side is strong.

Note that when characters used in mathematical expressions are described in the specification, italics and bold letters cannot be used due to the function of electronic application software, and thus are represented as roman letters and characters of normal thickness, respectively.

In order to improve the elevation angle perception accuracy, a sound propagation characteristics correction function using an adaptive filter is achieved by installing microphones outside and inside headphones and inserting microphones into auricles (Non Patent Literature 2).

### CITATION LIST

### Non Patent Literature

Non Patent Literature 1: Evaluation of Equalization Methods for Binaural Signals, Zora Scharer and Alexander Lindau, the 126th Convention 2009 May 7-10 Munich, Germany
Non Patent Literature 2: Natural Listening over Headphones in Augmented Reality Using Adaptive Filtering Techniques, Rishabh Ranjan and Woon-Seng Gan, IEEE/ACM TASLP, vol. 23, no. 11, November 2015

### SUMMARY OF INVENTION

### Technical Problem

However, the conventional art (Non Patent Literatures 1 and 2) is premised on a wearable speaker of a type that blocks the ear canal, and is not premised on a wearable open-ear speaker.

Therefore, an object of the present disclosure is to provide a sound propagation characteristics correction apparatus that corrects sound propagation characteristics for stereophonic sound reproduction with a wearable open-ear speaker.

### Solution to Problem

A sound propagation characteristics correction apparatus of the present disclosure includes a pseudo inverse filter generation unit and an acoustic signal correction unit.

The pseudo inverse filter generation unit generates a pseudo inverse filter by a function that smooths sound propagation characteristics from a speaker driver of the wearable open-ear speaker to the ear canal entrance. The acoustic signal correction unit corrects an acoustic signal on the basis of the pseudo inverse filter and transmits the corrected acoustic signal to the wearable open-ear speaker.

### Advantageous Effects of Invention

With the sound propagation characteristics correction apparatus of the present disclosure, it is possible to correct sound propagation characteristics for stereophonic sound reproduction with a wearable open-ear speaker.

### BRIEF DESCRIPTION OF DRAWINGS

FIG. 1 is a block diagram illustrating a functional configuration of a sound propagation characteristics correction apparatus of Example 1.

FIG. 2 is a flowchart illustrating an operation of the sound propagation characteristics correction apparatus of Example 1.

FIG. 3 is a graph illustrating a generation example of a kernel ridge pseudo inverse filter.

FIG. 4 is a graph illustrating a generation example of a mollifier (Gaussian function) pseudo inverse filter.

FIG. 5 is a graph illustrating a generation example of a mollifier (sinc function) pseudo inverse filter.

FIG. 6 is a graph illustrating a generation example of a mollifier (function obtained by smoothing a trapezoid) pseudo inverse filter.

FIG. 7 is a graph illustrating a generation example of a low-pass ensuring pseudo inverse filter.

FIG. 8 is a diagram illustrating a functional configuration example of a computer.

### DESCRIPTION OF EMBODIMENTS

Hereinafter, an embodiment of the present disclosure will be described in detail. Note that configuration units having the same functions are denoted by the same reference numerals, and redundant description will be omitted.

### Example 1

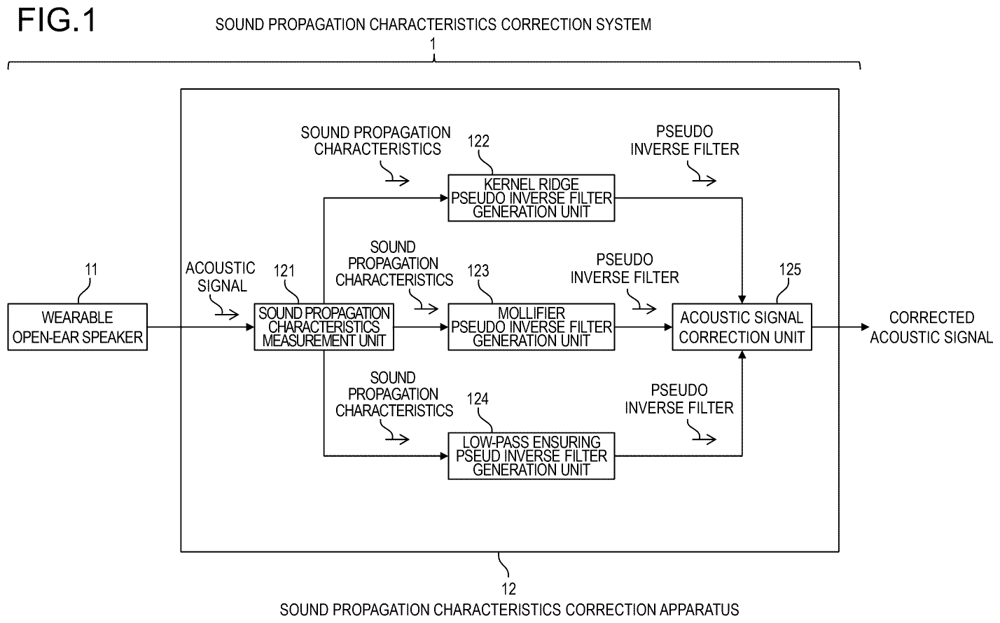

Hereinafter, a functional configuration of a sound propagation characteristics correction system and a sound propagation characteristics correction apparatus of Example 1 will be described with reference to FIG. 1. As illustrated in the drawing, a sound propagation characteristics correction system 1 includes a wearable open-ear speaker 11 and a sound propagation characteristics correction apparatus 12. Examples of the wearable open-ear speaker include open-ear earphones, open-ear headphones, and a neck speaker.

The sound propagation characteristics correction system 1 is characterized by generating a pseudo inverse filter that smooths sound propagation characteristics from the speaker driver of the wearable open-ear speaker to an ear canal, correcting an acoustic signal on the basis of the generated pseudo inverse filter, and reproducing the corrected acoustic signal from the wearable open-ear speaker.

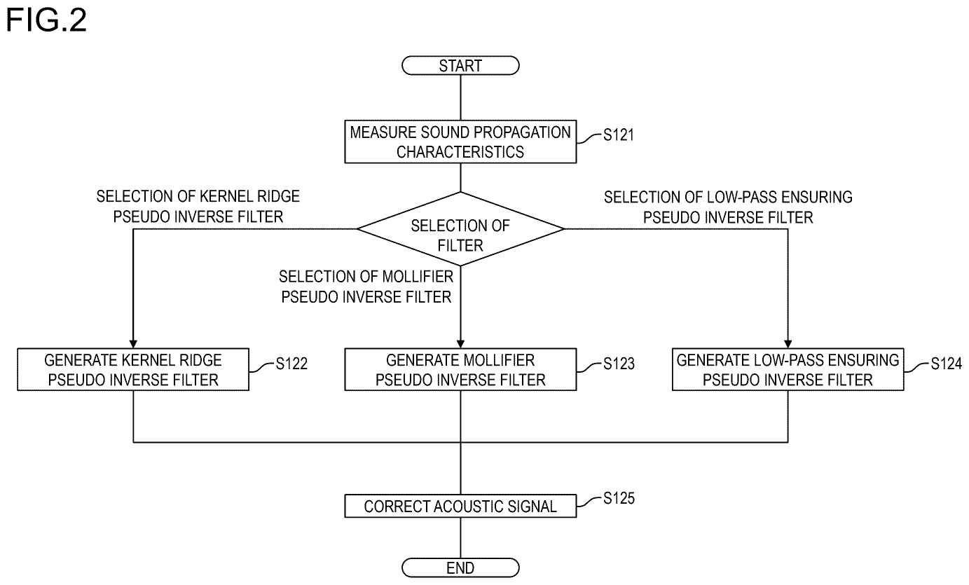

The sound propagation characteristics correction apparatus 12 includes a sound propagation characteristics measurement unit 121, a kernel ridge pseudo inverse filter generation unit 122, a mollifier pseudo inverse filter generation unit 123, a low-pass ensuring pseudo inverse filter generation unit 124, and an acoustic signal correction unit 125. Hereinafter, the operation of each component in the sound propagation characteristics correction apparatus 12 will be described in detail with reference to FIG. 2.

### <Sound Propagation Characteristics Measurement Unit 121>

The sound propagation characteristics measurement unit 121 measures sound propagation characteristics from the speaker driver of the wearable open-ear speaker 11 to the ear canal entrance using an arbitrary impulse response measurement method (S121). Note that, in a case where the sound propagation characteristics from the speaker driver of the wearable open-ear speaker 11 to the ear canal is measured and recorded in advance with another apparatus, the sound propagation characteristics measurement unit 121 can be omitted.

### <<Pseudo Inverse Filter Generation Units 122, 123, and 124>>

The pseudo inverse filter generation units 122, 123, and 124 described below are characterized by generating a pseudo inverse filter by a function that smooths sound propagation characteristics from the speaker driver of the wearable open-ear speaker to the ear canal entrance.

### <Kernel Ridge Pseudo Inverse Filter Generation Unit 122>

The kernel ridge pseudo inverse filter generation unit 122 generates a kernel ridge pseudo inverse filter that is a pseudo inverse filter using the kernel ridge regression (S122).

First, the kernel ridge pseudo inverse filter generation unit 122 detects a peak H(xₚₑₐₖ) and a notch H(x_{notch}) of the sound propagation characteristics from the wearable open-ear speaker to the ear canal.

$$H ( {x}_{peak} ) , H ( {x}_{notch} ) \qquad [ Math . 2 ]$$

Next, the kernel ridge pseudo inverse filter generation unit 122 acquires the reciprocals of the peak H(xₚₑₐₖ) and the notch H(x_{notch}).

$$1 / H ( {x}_{peak} ) , 1 / H ( {x}_{notch} ) \qquad [ Math . 3 ]$$

Next, the kernel ridge pseudo inverse filter generation unit 122 applies the kernel ridge regression based on the reciprocals of the peak and the notch to generate a kernel ridge pseudo inverse filter.

$$g ( α ) = {( H - W α )}^{T} ( H - W α ) + {λα}^{T} W α \qquad [ Math . 4 ]$$

g(α) is an error function. W represents a matrix having, as an element of the matrix, a value of a kernel function with each data point as an argument for the sound propagation characteristics H from the wearable open-ear speaker to the ear canal. α is a weight when the kernel functions are added. The second term of g(α) is a regularization term, and λ is a weight for regularization. The inverse filter uses i as a data point and adds the “kernel functions w(xᵢ, x)” by a weight di to obtain a form close to 1/H.

### <Mollifier Pseudo Inverse Filter Generation Unit 123>

The mollifier pseudo inverse filter generation unit 123 generates a mollifier pseudo inverse filter that is a pseudo inverse filter using a mollifier (S123).

First, the mollifier pseudo inverse filter generation unit 123 applies the below-described three types of mollifiers f(x) to the sound propagation characteristics H(x) from a wearable open-ear speaker earphone to the ear canal. The formula described below represents convolution of the mollifier f(x) and the sound propagation characteristics H(x) from the wearable open-ear speaker to the ear canal, and X is used to represent the convolution.

$${H}_{molified} ( X ) = \int H ( x ) f ( X - x ) dx \qquad [ Math . 5 ]$$

1) Gaussian function

$$f ( x ) = \frac{1}{√ 2 {πσ}^{2}} exp ( - \frac{{x}^{2}}{2 {σ}^{2}} ) \qquad [ Math . 6 ]$$

2) sinc function

$$f ( x ) = sin ( x ) / x \qquad [ Math . 7 ]$$

3) Function obtained by smoothing a trapezoid

$$f ( x ) = \{ \begin{matrix}exp ( - \frac{1}{1 - {\vert x \vert}^{2}} ) & ( \vert x \vert \leq 1 ) \\ 0 & ( \vert x \vert > 1 )\end{matrix} \qquad [ Math . 8 ]$$

The mollifier pseudo inverse filter generation unit 123 generates a mollifier pseudo inverse filter by taking the reciprocal of the sound propagation characteristics from the wearable open-ear speaker to the ear canal, the sound propagation characteristics being smoothed by applying the mollifier (S123).

### <Low-Pass Ensuring Pseudo Inverse Filter Generation Unit 124>

The low-pass ensuring pseudo inverse filter generation unit 124 takes a moving average of the sound propagation characteristics from the wearable open-ear speaker to the ear canal, and generates a low-pass ensuring pseudo inverse filter that is a pseudo inverse filter that ensures passage of a low frequency range of an inverse filter capable of designating the strength of regularization for each frequency (S124).

First, the low-pass ensuring pseudo inverse filter generation unit 124 takes a moving average of sound propagation characteristics from the wearable open-ear speaker to the ear canal.

Next, the low-pass ensuring pseudo inverse filter generation unit 124 generates low-pass filter-processed sound propagation characteristics obtained by applying a low-pass filter to the sound propagation characteristics after the moving average, and band-pass filter-processed sound propagation characteristics obtained by applying a band-pass filter.

Next, the low-pass ensuring pseudo inverse filter generation unit 124 generates an inverse filter capable of designating the strength of regularization for each frequency on the basis of the technique of Non Patent Literature 1 from the band-pass filter-processed sound propagation characteristics.

Next, the low-pass ensuring pseudo inverse filter generation unit 124 multiplies the low-pass filter-processed sound propagation characteristics by a constant so that the value of a high-pass end point of the low-pass filter-processed sound propagation characteristics matches the value of a low-pass end point of the band-pass filter-processed sound propagation characteristics.

Next, the low-pass ensuring pseudo inverse filter generation unit 124 generates the low-pass ensuring pseudo inverse filter by combining the inverse filter generated from the band-pass filter-processed sound propagation characteristics with the low-pass filter-processed sound propagation characteristics multiplied by the constant.

### <Acoustic Signal Correction Unit 125>

The acoustic signal correction unit 125 corrects the acoustic signal using any pseudo inverse filter of the pseudo inverse filters generated in steps S122, S123, and S124, and transmits the corrected acoustic signal to the wearable open-ear speaker (S125). It is assumed that the pseudo inverse filter used for correction can be selected by the user.

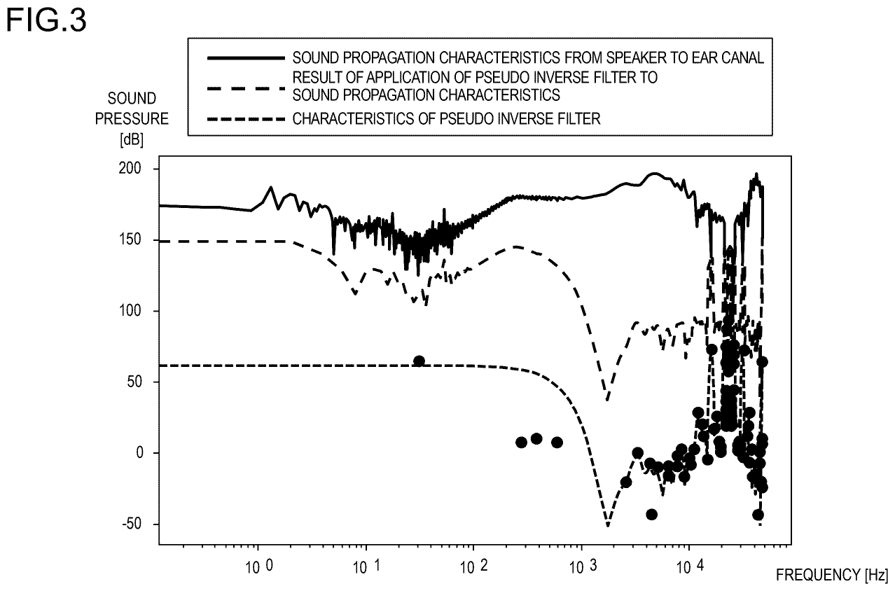

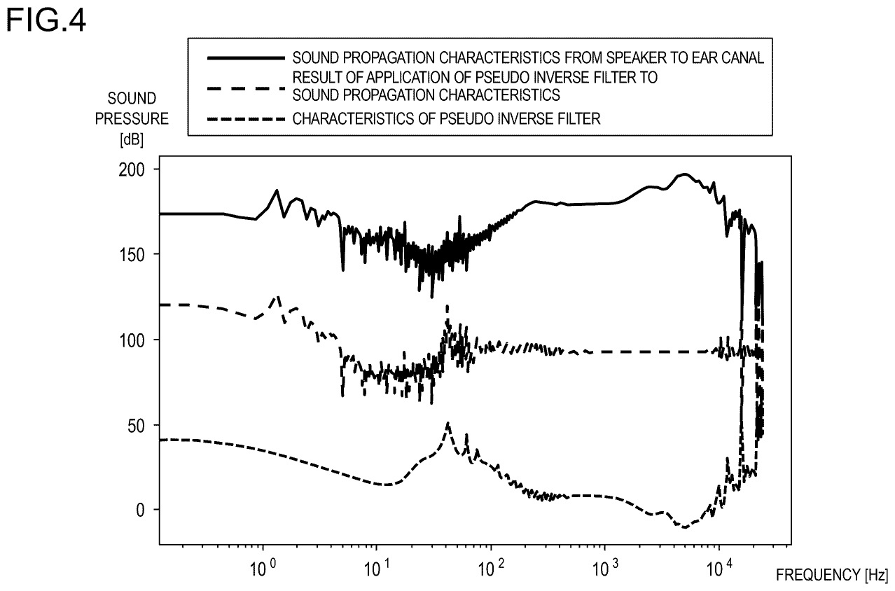

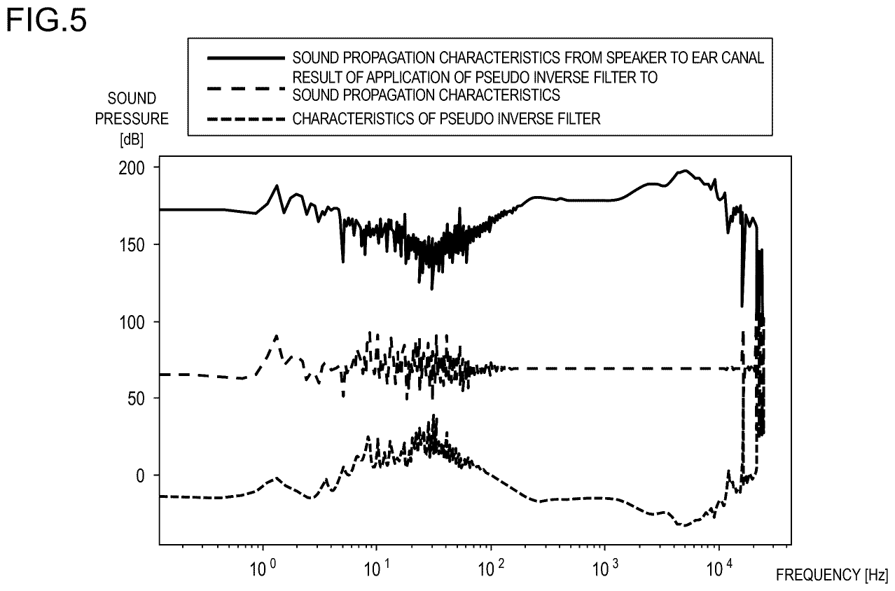

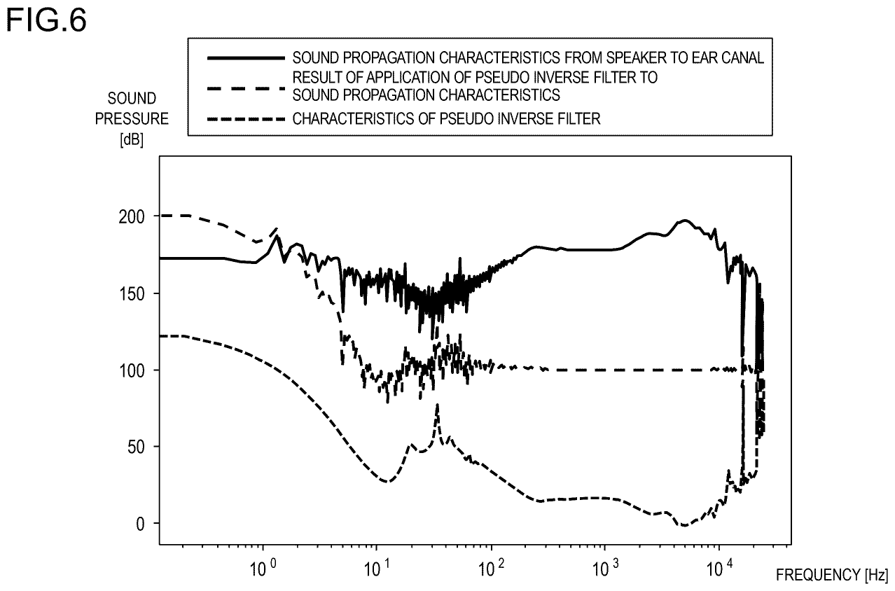

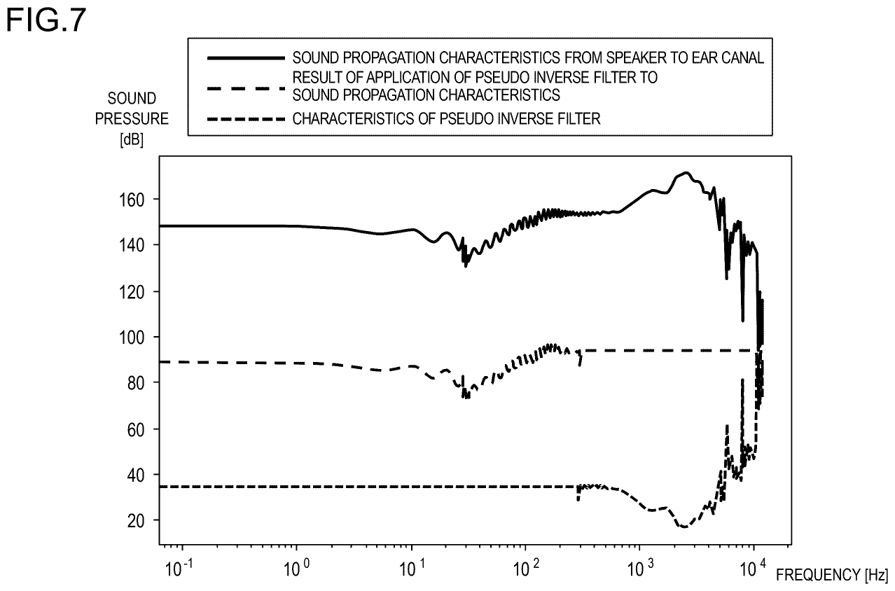

FIG. 3 illustrates a generation example of a kernel ridge pseudo inverse filter. FIG. 4 illustrates a generation example of a mollifier (Gaussian function) pseudo inverse filter. FIG. 5 illustrates a generation example of a mollifier (sinc function) pseudo inverse filter. FIG. 6 illustrates a generation example of a mollifier (function obtained by smoothing a trapezoid) pseudo inverse filter. FIG. 7 illustrates a generation example of a low-pass ensuring pseudo inverse filter. In any of the graphs of FIGS. 3 to 7, the vertical axis represents sound pressure [dB] and the horizontal axis represents frequency [Hz]. A solid line graph represents sound propagation characteristics from the wearable open-ear speaker to the ear canal, a broken line graph represents a result of applying the pseudo inverse filter to the sound propagation characteristics, and a dotted line graph represents characteristics of the pseudo inverse filter.

With the sound propagation characteristics correction system 1 and the sound propagation characteristics correction apparatus 12 of the present disclosure, stereophonic sound reproduction with high elevation angle perception accuracy using the wearable open-ear speaker is achieved.

In addition, with the sound propagation characteristics correction system 1 and the sound propagation characteristics correction apparatus 12 of the present disclosure, since the pseudo inverse filter can be generated without inserting the microphone into the auricle, the convenience of the user is improved.

The generation of the pseudo inverse filter using the kernel ridge regression (step S122) has an advantage that the pseudo inverse filter can be generated when only the positions of the peak and the notch of the frequency characteristics and the sound pressure value are known.

In Non Patent Literature 1, since the frequency characteristics are averaged by 10 times of measurement for one user, the burden on the user is excessive, but regarding the generation of the pseudo inverse filter using the mollifier (S123), this can be solved by smoothing while leaving information of the positions of the peak and the notch using the mollifier after one time of measurement.

Regarding the generation of the pseudo inverse filter (S124) that ensures the low-pass of the inverse filter of Non Patent Literature 1, the problem that the burden on the user is excessive in Non Patent Literature 1 can be solved by smoothing by taking a moving average. Further, the characteristic of reducing the low-frequency sound pressure, which is another problem of Non Patent Literature 1, has been solved by combining a low-pass filter.

### <Supplementary Note>

The device according to the present disclosure includes, for example, as a single hardware entity, an input unit that can be connected to a keyboard or the like, an output unit that can be connected to a liquid crystal display or the like, a communication unit that can be connected to a communication device (e.g., a communication cable) capable of communicating with the outside of the hardware entity, a central processing unit (CPU which may include a cache memory or a register), a RAM or a ROM which is a memory, an external storage device as a hard disk, and a bus that connects the input unit, the output unit, the communication unit, the CPU, the RAM, the ROM, and the external storage device so that data can be exchanged therebetween. In addition, a device (drive) or the like that can perform write and read with respect to a recording medium such as a CD-ROM may be provided in the hardware entity as necessary. Examples of a physical entity including such a hardware resource include a general-purpose computer and the like.

The external storage device of the hardware entity stores a program required to implement the above-described functions, data required to process the program, and the like (it is not limited to the external storage device and the program may be stored, for example, in a ROM, which is a read-only storage device). In addition, data or the like obtained by processing the program is appropriately stored in a RAM, an external storage device, or the like.

In the hardware entity, each program stored in the external storage device (or ROM or the like) and data required for processing of each program are read into a memory as necessary and are appropriately interpreted and processed by the CPU. As a result, the CPU implements a predetermined function (each component represented as . . . unit, . . . means, or the like).

The present disclosure is not limited to the above-described embodiment, and appropriate modifications can be made without departing from the gist of the present disclosure. In addition, the pieces of processing described in the above embodiment may be executed not only chronologically in accordance with the described order, but also in parallel or individually in accordance with the processing capability of a device that executes the processing or as necessary.

As described above, in a case in which the processing function in the hardware entity (the device of the present disclosure) described in the above embodiment is achieved by a computer, details of processing of the function that the hardware entity should have are written by a program. Then, as the computer executes the program, the processing function of the hardware entity is implemented on the computer.

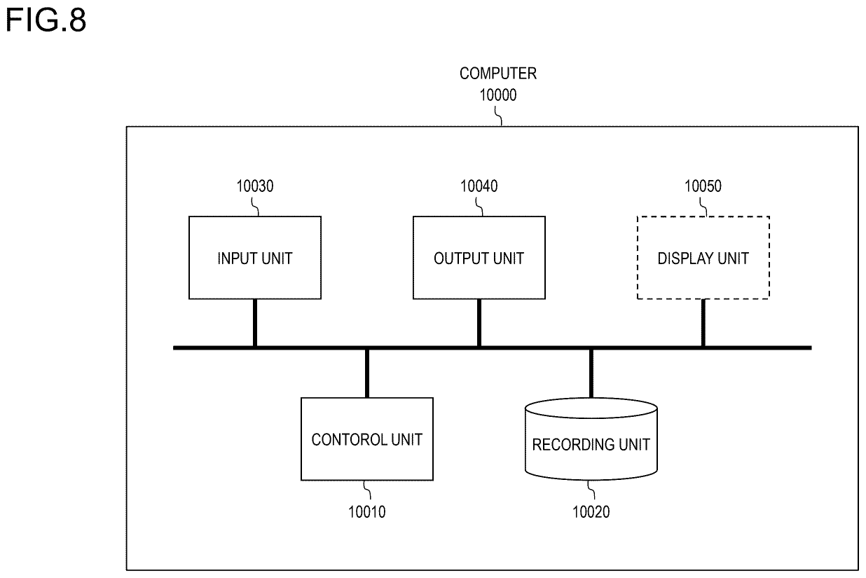

The various kinds of processing described above can be performed by causing a recording unit 10020 of a computer 10000 illustrated in FIG. 8 to read a program for executing each step of the method described above and causing a control unit 10010, an input unit 10030, an output unit 10040, and the like to operate.

The program in which details of processing are written can be recorded in a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

In addition, distribution of the program is performed by, for example, selling, transferring, or renting a portable recording medium such as a DVD or a CD-ROM in which the program is recorded. Further, the program may be stored in a storage device of a server computer, and the program may be distributed by transferring the program from the server computer to another computer via a network.

For example, a computer that executes such a program first temporarily stores a program recorded on a portable recording medium or a program transferred from a server computer in a storage device of the own device. When executing processing, the computer reads the program stored in the recording medium of the own device and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above processing may also be executed by a so-called application service provider (ASP) service that implements a processing function only by an execution instruction and result acquisition without transferring a program from the server computer to the computer. Note that it is assumed that the program according to the present mode includes information used for processing performed by an electronic calculator and conforms to the program (data that is not a direct command for the computer but has a characteristic of defining processing of the computer, or the like).

In addition, although the hardware entity is formed by executing a predetermined program in a computer in this mode, at least some of the processing details may be implemented by hardware.

1. A sound propagation characteristics correction apparatus comprising:
processing circuitry configured to
generate a pseudo inverse filter by a function that smooths sound propagation characteristics from a speaker driver of a wearable open-ear speaker to an ear canal entrance; and
correct an acoustic signal on a basis of the pseudo inverse filter and transmits the corrected acoustic signal to the wearable open-ear speaker.

2. The sound propagation characteristics correction apparatus according to claim 1, the processing circuitry configured to generate a kernel ridge pseudo inverse filter that is a pseudo inverse filter using kernel ridge regression.

3. The sound propagation characteristics correction apparatus according to claim 1, the processing circuitry configured to
generate a mollifier pseudo inverse filter that is a pseudo inverse filter using a mollifier.

4. The sound propagation characteristics correction apparatus according to claim 1, the processing circuitry configured to take a moving average of the sound propagation characteristics, and generates a low-pass ensuring pseudo inverse filter that is a pseudo inverse filter that ensures passage of a low frequency range of an inverse filter capable of designating strength of regularization for each frequency.

5. The sound propagation characteristics correction apparatus according to claim 4,
the processing circuitry configured to
generate low-pass filter-processed sound propagation characteristics obtained by applying a low-pass filter to sound propagation characteristics after a moving average, and band-pass filter-processed sound propagation characteristics obtained by applying a band-pass filter,
generate an inverse filter capable of designating strength of regularization for each frequency from the band-pass filter-processed sound propagation characteristics,
multiply the low-pass filter-processed sound propagation characteristics by a constant so that a value of a high-pass end point of the low-pass filter-processed sound propagation characteristics matches a value of a low-pass end point of the band-pass filter-processed sound propagation characteristics, and
generate the low-pass ensuring pseudo inverse filter by combining an inverse filter generated from the band-pass filter-processed sound propagation characteristics with the low-pass filter-processed sound propagation characteristics multiplied by the constant.

6. A sound propagation characteristics correction method executed by a sound propagation characteristics correction apparatus, the sound propagation characteristics correction method comprising:
generating a pseudo inverse filter by a function that smooths sound propagation characteristics from a speaker driver of a wearable open-ear speaker to an ear canal entrance; and
correcting an acoustic signal on a basis of the pseudo inverse filter and transmitting the corrected acoustic signal to the wearable open-ear speaker.

7. A non-transitory computer readable medium storing a computer program for causing a computer to function as the sound propagation characteristics correction apparatus according to claim 1.
